(19) United States
(12) Patent Application Publication
(10) Pub. No.: US 2008/0181134 A1
(43) Pub. Date: Jul. 31, 2008

(54) SYSTEM AND METHOD FOR MONITORING LARGE-SCALE DISTRIBUTION NETWORKS BY DATA SAMPLING

(76) Inventors: Nikolaos Anerousis, Chappaqua, NY (US); Hani T. Jamjoom, White Plains, NY (US); Debanjan Saha, Mohegan Lake, NY (US); Shu Tao, White Plains, NY (US); Jin Zhou, Software Park (CN)

Correspondence Address: Frank Chau, Esq.;F. CHAU & ASSOCIATES, LLC, 130 Woodbury Road, Woodbury, NY, 11797, US

(21) Appl. No.: 11/668,225

(22) Filed: Jan. 29, 2007

(51) Int. Cl. H04L 12/28

(52) U.S. Cl. 370/255; 370/242

(57) ABSTRACT

A method for monitoring a network includes: identifying a plurality of groups of devices in a network, wherein each of the plurality of groups of devices is a set of related devices; sampling a status of a group of nodes in each of the plurality of groups of devices, wherein each of the plurality of groups of devices has a plurality of groups of nodes; and determining a status of the network based on the sampled status of the group of nodes in each of the plurality of groups of devices.

### BACKGROUND OF THE INVENTION

1. Technical Field

The present invention relates to network management, and more particularly, to a system and method for monitoring large-scale distribution networks by data sampling.

2. Discussion of the Related Art

Managing large-scale distribution networks such as computer, cable and telecommunications networks that process millions of transactions daily is an important and challenging task. Of the various challenges associated with such network management, it is particularly important to monitor the status of the network in real-time. By using data obtained via real-time monitoring, an administrative center can quickly detect and solve problems in the network, and thus, prevent these problems from spreading throughout the network. However, providing efficient real-time monitoring to a network management entity such as an administrative or operation center is not cost-effective due to the overhead required to monitor the large number of devices in these networks.

Known approaches to large-scale distribution network management include reactive monitoring and aggregated monitoring. An exemplary reactive monitoring approach is discussed in , R. Sasisekharan, V. Seshadri, and S. M. Weiss, “Data Mining and forecasting in Large-Scale Telecommunication Networks”, IEEE Intelligent Systems and Their Applications 11(1): 37-43, Feb. 1996. Exemplary aggregated monitoring approaches are discussed in , R. R. Kompella, J. Yates, A. Greenberg, and A. C. Snoeren, “IP Fault Localization Via Risk Modeling”, In Proceedings of Networked Systems Design and Implementation (NSDI), 2005, S. Kandula, D. Katabi, and J. P. Vasseur, “Shrink: A Tool for Failure Diagnosis in IP Networks”, ACM SIGCOMM Workshop on mining network data (MineNet-05), Philadelphia, Pa., August, 2005, and U.S. Pat. No. 5,751,964, entitled, “System and Method for Automatic Determination of Thresholds in Network Management”, issued May 12, 1998 to Ordanic et al.

Reactive monitoring generally involves using an operation center to monitor only affected network devices when a problem is reported. Thus, although information collected during this process is helpful in problem diagnosis, it is not helpful for problem prevention. Aggregated monitoring generally involves using an operation center that monitors a network at an aggregated level. For example, the operation center of a cable network can rely on a management information database (MIB) in cable modem terminal systems (CMTSs) to monitor the availability of modems attached to the CMTSs. However, this process does not provide detailed status information for all devices in the network.

Accordingly, there is a need for a technique of managing large-scale distribution networks that is capable of providing real-time monitoring in an efficient and cost-effective manner.

### SUMMARY OF THE INVENTION

In an exemplary embodiment of the present invention, a method for monitoring a network comprises: identifying a plurality of groups of devices in a network, wherein each of the plurality of groups of devices is a set of related devices; sampling a status of a group of nodes in each of the plurality of groups of devices, wherein each of the plurality of groups of devices has a plurality of groups of nodes; and determining a status of the network based on the sampled status of the group of nodes in each of the plurality of groups of devices.

The plurality of groups of devices in the network are identified by: receiving a topology of the network or history monitoring data of the network as an input; and when the topology of the network is received, determining the plurality of groups of devices based on a connectivity of nodes in the topology of the network; or when the history monitoring data of the network is received, determining the plurality of groups of devices based on history data collected from nodes in the network.

The plurality of groups of devices in the network are also identified by: receiving a partial topology of the network and history monitoring data of the network as an input; and determining the plurality of groups of devices based on a connectivity of nodes in the partial topology of the network and history data collected from nodes in the network.

The status of a group of nodes in each of the plurality of groups of devices is sampled by sending probes to a group of nodes in each of the plurality of groups of devices. More probes are sent to groups of devices having a larger number of devices than are sent to groups of devices having a smaller number of devices. When groups of devices have the same number of devices, more problems are sent to a group of devices that has devices with higher status variabilities that are sent to a group devices that has devices with lower status variabilities.

The status of the network is determined by: estimating a status of each of the plurality of groups of devices by using the sampled status of a group of nodes of each of the plurality of groups of devices; and generating a status estimate of the plurality of groups of devices.

The method further comprises generating a status report for the network by using the status estimate to identify portions of the network that are having problems. The method further comprises: generating current problem signatures by using the status estimate of the plurality of groups of devices; and comparing the current problem signatures with previous problem signatures to identify a problem currently occurring in the network. The method further comprises: combining the current problem signatures with a predicted status estimate of the plurality of groups of devices to determine whether a future problem is going to occur in the network; and determining which actions to take to prevent the future problem from occurring in the network.

In an exemplary embodiment of the present invention, a computer program product comprises a computer useable medium having computer program logic recorded thereon for monitoring a network, the computer program logic comprises: program code for identifying a plurality of groups of devices in a network, wherein each of the plurality of groups of devices is a set of related devices; program code for sampling a status of a group of nodes in each of the plurality of groups of devices, wherein each of the plurality of groups of devices has a plurality of groups of nodes; and program code for determining a status of the network based on the sampled status of the group of nodes in each of the plurality of groups of devices.

The program code of identifying the plurality of groups of devices in the network comprises: program code for receiving a topology of the network or history monitoring data of the network as an input; and program code for determining the plurality of groups of devices based on a connectivity of nodes in the topology of the network, when the topology of the network is received; or program code for determining the plurality of groups of devices based on history data collected from nodes in the network, when the history monitoring data of the network is received.

The program code for identifying the plurality of groups of devices in the network comprises: program code for receiving a partial topology of the network and history monitoring data of the network as an input; and program code for determining the plurality of groups of devices based on a connectivity of nodes in the partial topology of the network and history data collected from nodes in the network.

The status of a group of nodes in each of the plurality of groups of devices is sampled by sending probes to a group of nodes in each of the plurality of groups of devices. More probes are sent to groups of devices having a larger number of devices than are sent to groups of devices having a smaller number of devices. When groups of devices have the same number of devices, more probes are sent to a group of devices that has devices with higher status variabilities than are sent to a group devices that has devices with lower status variabilities.

The program code for determining the status of the network comprises: program code for estimating a status of each of the plurality of groups of devices by using the sampled status of a group of nodes of each of the plurality of groups of devices; and program code for generating a status estimate of the plurality of groups of devices.

The computer program product further comprises program code for generating a status report for the network by using the status estimate to identify portions of the network that are having problems. The computer program product further comprises: program code for generating current problem signatures by using the status estimate of the plurality of groups of devices; and program code for comparing the current problem signatures with previous problem signatures to identify a problem currently occurring in the network.

The computer program product further comprises: program code for combining the current problem signatures with a predicted status estimate of the plurality of groups of devices to determine whether a future problem is going to occur in the network; and program code for determining which actions to take to prevent the future problem from occurring in the network.

In an exemplary embodiment of the present invention, a system for monitoring a network comprises: a memory device for storing a program; a processor in communication with the memory device, the processor operative with the program to: identify a plurality of groups of devices in a network, wherein each of the plurality of groups of devices is a set of related devices; sample a status of a group of nodes in each of the plurality of groups of devices, wherein each of the plurality of groups of devices has a plurality of groups of nodes; and determine a status of the network based on the sampled status of the group of nodes in each of the plurality of groups of devices.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 illustrates a system for monitoring large-scale distribution networks according to an exemplary embodiment of the present invention; and

FIG. 2 illustrates granular groups inferred from network topology information according to an exemplary embodiment of the present invention.

### DETAILED DESCRIPTION OF EXEMPLARY EMBODIMENTS

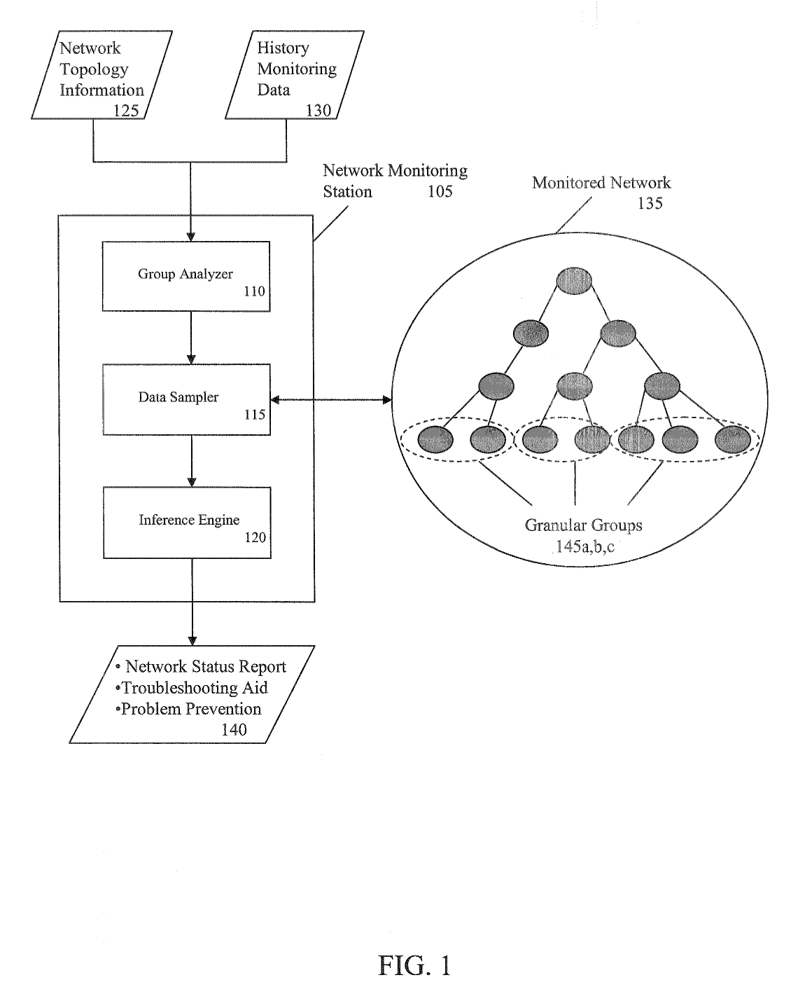

FIG. 1 illustrates a system for monitoring large-scale distribution networks according to an exemplary embodiment of the present invention.

As shown in FIG. 1, a network monitoring station 105 includes a group analyzer 110, a data sampler 115 and an inference engine 120. The network monitoring station 105 has an input interface for receiving network topology information 125 and/or history monitoring data 130. The network monitoring station 105 has a network interface for connecting the data sampler 115 to a monitored network 135 such as a large-scale distribution network, so that the data sampler 115 can sample devices in the monitored network 135. The network monitoring station 105 also has an output interface for outputting information 140 associated with the monitored network 135 that is inferred by the inference engine 120.

An exemplary implementation of the system shown in FIG. 1 will now be discussed.

In FIG. 1, using the network topology information 125, e.g., the topology of the monitored network 135, the group analyzer 110 identifies granular groups 145a, b, c in the monitored network 135. Each granular group 145a, b, c is a subset of devices that have correlated status. For example, in a large-scale distribution network such as a cable network, a set of cable modems attached to the same repeater can be considered a granular group.

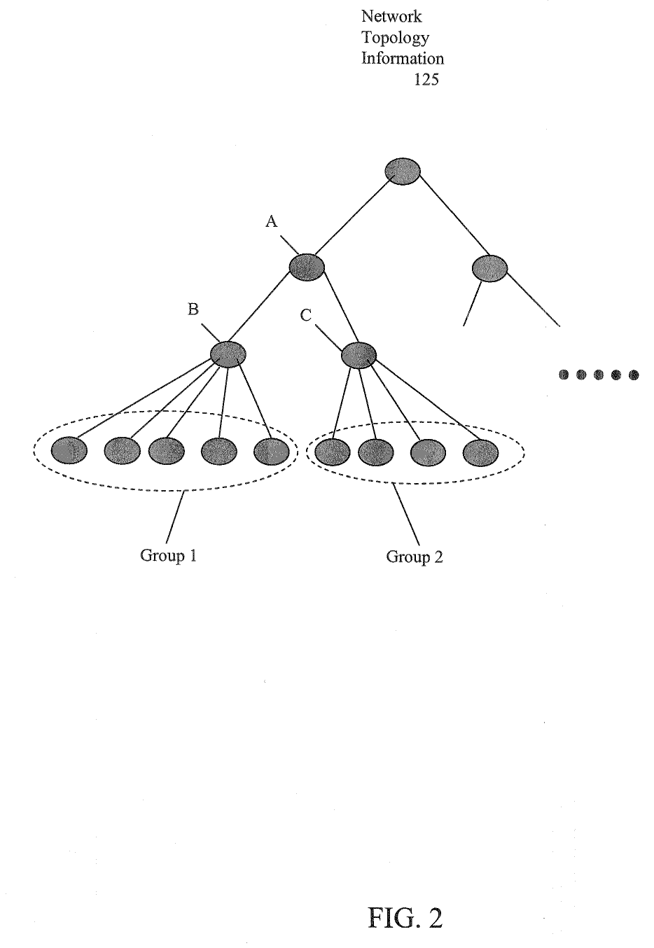

The granular groups 145a, b, c are identified by using the connectivity of the nodes in the network topology. Because large-scale distribution networks generally assume a tree topology, a granular group (e.g., Group 1, or Group 2) may contain a set of leaf nodes (e.g., cable modems) that are exclusively attached to an upper-level node (e.g., a repeater B or C, respectively, that is attached to a higher-level repeater A or a cable modem terminal system (CMTS) interface A), as shown in FIG. 2.

If the network topology information 125 is not available, the group analyzer 110 can use, for example, history monitoring data 130 that is collected from a set of leaf nodes to infer the granular groups. The history monitoring data 130 includes, for example, data collected when problems are detected in the monitored network 135. Granular group inference can be equivalent to identifying leaf nodes that share similar risks of failure and/or problems in the monitored network 135. Thus, given sufficient history monitoring data 130, the granular groups can be inferred without using the network topology information 125. Further, given partial network topology information 125 and some history monitoring data 130, the group analyzer 110 can combine the two to derive a more accurate granular grouping.

Using the identified granular groups, the data sampler 115 samples each group with a small number of probes such as data packets or signals. For example, if a group I contains Ni nodes, the data sampler 115 probes only Mi nodes, where Mi<<Ni. In each round of sampling, the Mi nodes can be randomly selected from the group I. The value of Mi is a function of both the size of the group (Ni) and the variability of the status of the nodes in that group. Thus, for example, more probes should be sent to larger groups to derive more accurate estimates of the group status. Further, for groups with the same size, those whose members show a higher status variability should receive more probes, so that the collected samples are more representative of the overall status of these groups. In practice, the selection of Mi can be tuned to reduce the possibility of noise in the sampled data (e.g., a cable modem can be accidentally powered off during sampling), as well as minimizing the costs associated with probing.

After data sampling is complete, the inference engine 120 estimates the status of each group based on a function ƒ(x_{—}1, x_{—}2, . . . , x_Mi), which takes the Mi sampled data as an input, and outputs the status estimate of the entire group. It is to be understood that this estimation is not always accurate due to sampling noise. The inference engine 120 takes this potentially noisy input and conducts the following analyses.

In one example analysis, the inference engine 120 derives an overall network status report by using the above-described group-based estimation to generate reports that identify parts of the monitored network 135 that are having problems.

In another example analysis, the inference engine 120 diagnoses problems within the monitored network 135 by using the status estimates for all the granular groups as problem signatures. Compared to the results obtained by probing an entire network, the problem signature derived from the sampling has a much smaller dimension. This enables easier mapping between problem signatures and historical fixes or knowledge bases. This mapping can be done either manually or automatically through machine learning techniques, where the system can identify a list of possible solutions for problems observed in the current sample.

In yet another example analysis, the inference engine 120 uses the status estimates derived from the sampling to proactively detect problems in the monitored network 135. Since the status parameter is not necessarily binary (e.g., failed or not), it could also be a continuous variable (e.g., a signal-to-noise ratio (SNR) on the channel to a cable modem). In practice, it is often the case that when the values of these parameters fall in a certain range, it could potentially trigger more serious problems in the future. For example, if the SNR measured from a group of nodes is low, it could mean that the upper-level node needs maintenance or replacement. By using the status estimates, problems such as this could be detected before they affect the monitored network 135.

In accordance with an exemplary embodiment of the present invention, because the status of the sampled nodes represents the status of corresponding nodes, the status of an entire monitored network can be inferred from the sampled data. Further, since the number of granular groups is much smaller than the total number of nodes in the network, this approach incurs much less over head than otherwise would be needed to monitor the entire network. Therefore, this system can be used in real-time management of large-scale distribution networks.

It is to be understood that in addition to the components discussed above, the network monitoring station 105 may include or be embodied as a computer coupled to an operator's console. The computer includes a central processing unit (CPU) and a memory connected to an input device and an output device. The CPU can include or be coupled to the group analyzer 110, the data sampler 115 and the inference engine 120.

The memory includes a random access memory (RAM) and a read-only memory (ROM). The memory can also include a database, disk drive, tape drive, etc., or a combination thereof. The RAM functions as a data memory that stores data used during execution of a program in the CPU and is used as a work area. The ROM functions as a program memory for storing a program executed in the CPU. The input is constituted by a keyboard, mouse, etc., and the output is constituted by a liquid crystal display (LCD), cathode ray tube (CRT) display, printer, etc.

The operation of the system can be controlled from the operator's console, which includes a controller (e.g., a keyboard, and a display). The operator's console communicates with the PC so that data collected, for example, by the group analyzer 110, the data sampler 115 and the inference engine 120 can be viewed on the display. The PC can be configured to operate and display information provided by the group analyzer 110, the data sampler 115 and the inference engine 120 absent the operator's console, by using, for example, the input and output devices, to execute certain tasks performed by the controller and display.

It should be understood that the present invention may be implemented in various forms of hardware, software, firmware, special purpose processors, or a combination thereof. In one embodiment, the present invention may be implemented in software as an application program tangibly embodied on a program storage device (e.g., magnetic floppy disk, RAM, CD ROM, DVD, ROM, and flash memory). The application program may be uploaded to, and executed by, a machine comprising any suitable architecture.

It should also be understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It should be further understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A method for monitoring a network, the method comprising:
identifying a plurality of groups of devices in a network, wherein each of the plurality of groups of devices is a set of related devices;
sampling a status of a group of nodes in each of the plurality of groups of devices, wherein each of the plurality of groups of devices has a plurality of groups of nodes; and
determining a status of the network based on the samples status of the group of nodes in each of the plurality of groups of devices.

2. The method of claim 1, wherein the plurality of groups of devices in the network are identified by:
receiving a topology of the network or history monitoring data of the network as an input; and
when the topology of the network is received, determining the plurality of groups of devices based on a connectivity of nodes in the topology of the network; or
when the history monitoring data of the network is received, determining the plurality of groups of devices based on history data collected from nodes in the network.

3. The method of claim 1, wherein the plurality of groups of devices in the network are identified by:
receiving a partial topology of the network and history monitoring data of the network as an input; and
determining the plurality of groups of devices based on a connectivity of nodes in the partial topology of the network and history data collected from nodes in the network.

4. The method of claim 1, wherein the status of a group of nodes in each of the plurality of groups of devices is sampled by sending probes to a group of nodes in each of the plurality of groups of devices.

5. The method of claim 4, wherein more probes are sent to groups of devices having a larger number of devices than are sent to groups of devices having a smaller number of devices.

6. The method of claim 4, wherein when groups of devices have the same number of devices, more probes are sent to a group of devices that has devices with higher status variabilities than are sent to a group devices that has devices with lower status variabilities.

7. The method of claim 1, wherein the status of the network is determined by:
estimating a status of each of the plurality of groups of devices by using the sampled status of a group of nodes of each of the plurality of groups of devices; and
generating a status estimate of the plurality of groups of devices.

8. The method of claim 7, further comprising:
generating a status report for the network by using the status estimate to identify portions of the network that are having problems.

9. The method of claim 8, further comprising:
generating current problem signatures by using the status estimate of the plurality of groups of devices; and
comparing the current problem signatures with previous problem signatures to identify a problem currently occurring in the network.

10. The method of claim 9, further comprising:
combining the current problem signatures with a predicted status estimate of the plurality of groups of devices to determine whether a future problem is going to occur in the network; and
determining which actions to take to prevent the future problem from occurring in the network.

11. A computer program product comprising a computer useable medium having computer program logic recorded thereon for monitoring a network, the computer program logic comprising:
program code for identifying a plurality of groups of devices in a network, wherein each of the plurality of groups of devices is a set of related devices;
program code for sampling a status of a group of nodes in each of the plurality of groups of devices, wherein each of the plurality of groups of devices has a plurality of groups of nodes; and
program code for determining a status of the network based on the sampled status of the group of nodes in each of the plurality of groups of devices.

12. The computer program product of claim 11, wherein the program code for identifying the plurality of groups of devices in the network comprises:
program code for receiving a topology of the network or history monitoring data of the network as an input; and
program code for determining the plurality of groups of devices based on a connectivity of nodes in the topology of the network, when the topology of the network is received; or
program code for determining the plurality of groups of devices based in history data collected from nodes in the network, when the history monitoring data of the network is received.

13. The computer program product of claim 11, wherein the program code for identifying the plurality of groups of devices in the network comprises:
program code for receiving a partial topology of the network and history monitoring data of the network as an input; and
program code for determining the plurality of groups of devices based on a connectivity of nodes in the partial topology of the network and history data collected from nodes in the network.

14. The computer program product of claim 11, wherein the status of a group of nodes in each of the plurality of groups of devices is sampled by sending probes to a group of nodes in each of the plurality of groups of devices.

15. The computer program product of claim 14, wherein more probes are sent to groups of devices having a larger number of devices than are sent to groups of devices having a smaller number of devices.

16. The computer program product of claim 14, wherein when groups of devices have the same number of devices, more probes are sent to a group of devices that has devices with higher status variabilities than are sent to a group devices that has devices with lower status variabilities.

17. The computer program product of claim 11, wherein the program code for determining the status of the network comprises:
program code for estimating a status of each of the plurality of groups of devices by using the sampled status of a group of nodes of each of the plurality of groups of devices; and
program code for generating a status estimate of the plurality of groups of devices.

18. The computer program product of claim 17, further comprising:
program code for generating a status report for the network by using the status estimate to identify portions of the network that are having problems.

19. The computer program product of claim 18, further comprising:
program code for generating current problem signatures by using the status estimate of the plurality of groups of devices; and
program code for comparing the current problem signatures with previous problem signatures to identify a problem currently occurring in the network.

20. The computer program product of claim 19, further comprising:
program code for combining the current problem signatures with a predicted status estimate of the plurality of groups of devices to determine whether a future problem is going to occur in the network; and
program code for determining which actions to take to prevent the future problem from occurring in the network.

21. A system for monitoring a network, the system comprising:
a memory device for storing a program;
a processor in communication with the memory device, the processor operative with the program to:
identify a plurality of groups of devices in a network, wherein each of the plurality of groups of devices is a set of related devices;
sample a status of a group of nodes in each of the plurality of groups of devices, wherein each of the plurality of groups of devices has a plurality of groups of nodes; and
determine a status of the network based on the sampled status of the group of nodes in each of the plurality of groups of devices.
